(19) United States
(12) Patent Application Publication
(10) Pub. No.: US 2026/0249706 A1
(43) Pub. Date: Aug. 27, 2026

(54) BATTERY ELECTRIC VEHICLE

(71) Applicant: TOYOTA JIDOSHA KABUSHIKI KAISHA, Toyota-shi (JP)

(72) Inventor: Norimi ASAHARA, Numazu-shi (JP)

(73) Assignee: TOYOTA JIDOSHA KABUSHIKI KAISHA, Toyota-shi (JP)

(21) Appl. No.: 19/385,172

(22) Filed: Nov. 11, 2025

(30) Foreign Application Priority Data
Feb. 21, 2025 (JP) 2025-026624

(51) Int. Cl. B60L 15/20; B60L 50/60; G05B 13/04

(52) U.S. Cl. CPC B60L 15/20; B60L 50/60; G05B 13/041; B60L 2240/62

(57) ABSTRACT

The storage device of the battery electric vehicle stores a plurality of virtual vehicle models for executing the travel control and internal information of the battery electric vehicle. The processing circuit of the battery electric vehicle executes driving control of the battery electric vehicle including travel control that has simulated traveling of a plurality of virtual vehicles. In the driving control, when the destination information of the battery electric vehicle is set, the route characteristics from the current location of the battery electric vehicle to the destination are estimated based on the destination information. In addition, the recommendation vehicle in accordance with the route characteristics is selected from among the virtual vehicles. Then, the travel control that has simulated the traveling of the recommendation vehicle is executed based on the internal information and the virtual vehicle model corresponding to the recommendation vehicle.

### CROSS-REFERENCE TO RELATED APPLICATION

This application claims priority to Japanese Patent Application No. 2025-026624 filed on February 21, 2025. The disclosure of the above-identified application, including the specification, drawings, and claims, is incorporated by reference herein in its entirety.

### BACKGROUND

### Technical Field

The present disclosure relates to a battery electric vehicle including an electric motor as a power source.

### Description of Related Art

Japanese Unexamined Patent Application Publication No. 2022-030862 (JP 2022-030862 A) discloses a battery electric vehicle that can simulate a manual shifting operation of an engine vehicle that uses an internal combustion engine as a power source and that is equipped with a manual transmission, by controlling an electric motor. The battery electric vehicle in the related art includes a pseudo shift lever and causes the electric motor to output torque in accordance with a shift position of the pseudo shift lever and an accelerator operation amount. The battery electric vehicle in the related art also calculates a virtual engine rotation speed based on the shift position of the pseudo shift lever and the accelerator operation amount and generates an engine sound in accordance with the virtual engine rotation speed.

### SUMMARY

According to the technique of JP 2022-030862 A, for example, it is also possible to reproduce the manual shifting operations or the engine sounds of multiple engine vehicles that are different in type of the internal combustion engine, type of the vehicle in which the internal combustion engine is mounted, or the like. In addition, by expanding a range of selection of such a virtual vehicle, it is possible to provide a driver with a traveling experience in which traveling of the virtual vehicle that suits the preference of the driver of the battery electric vehicle is simulated. However, in a case where the traveling experience in which the traveling of the virtual vehicle selected by the driver is simulated does not match what the driver has expected, there is a possibility that the virtual vehicle is disregarded in subsequent selections. In a case where a traveling experience with low satisfaction continues, there is even a possibility that the selection itself of the virtual vehicle is disregarded.

The present disclosure has been made in consideration of the above-described problem. One object of the present disclosure is to suppress, when the traveling experiences in which traveling of a plurality of virtual vehicles is simulated are provided to a driver using a battery electric vehicle, a decrease in satisfaction of various traveling experiences in which the traveling of the virtual vehicles is simulated.

One aspect of the present disclosure is a battery electric vehicle, and the battery electric vehicle includes the following features.

The battery electric vehicle includes an electric motor as a power source for traveling.

The battery electric vehicle is configured to execute travel control simulating traveling of a plurality of virtual vehicles.

The battery electric vehicle includes one or more storage devices, and one or more processing circuits.

The one or more storage devices are configured to store a plurality of virtual vehicle models for executing the travel control, and internal information of the battery electric vehicle.

The one or more processing circuits are configured to execute driving control of the battery

electric vehicle that includes the travel control.

The one or more processing circuits are configured to, in the driving control,

estimate, in a case where destination information of the battery electric vehicle is set, route characteristics from a current location of the battery electric vehicle to a destination based on the destination information,

select a recommendation vehicle in accordance with the route characteristics from among the virtual vehicles, and

execute, based on the internal information and a virtual vehicle model corresponding to the recommendation vehicle, travel control simulating traveling of the recommendation vehicle.

One of the reasons why the traveling experience in which the traveling of the virtual vehicle selected by the driver is simulated does not match what the driver has expected is considered to be that characteristics of a road on which the battery electric vehicle travels while the travel control simulating the traveling of the virtual vehicle is being executed do not match vehicle characteristics of the virtual vehicle. In this regard, according to the present disclosure, the route characteristics from the current location of the battery electric vehicle to the destination are estimated based on the destination information of the battery electric vehicle, and the recommendation vehicle in accordance with the route characteristics is selected from among the virtual vehicles. Then, the travel control simulating the traveling of the recommendation vehicle is executed based on the virtual vehicle model corresponding to the recommendation vehicle and the internal information of the battery electric vehicle. Therefore, it is possible to suppress a decrease in satisfaction of the traveling experience in which the traveling of the virtual vehicle is simulated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a battery electric vehicle according to an embodiment;

FIG. 2 is a diagram showing a configuration of a control device related to travel control of a vehicle;

FIG. 3 is a diagram showing a configuration of a control device related to sound control of the vehicle;

FIG. 4 is a diagram illustrating a setting example of a recommendation vehicle;

FIG. 5 is a diagram illustrating an application example of the setting of the recommendation vehicle; and

FIG. 6 is a flowchart showing computer processing at the time of setting of the recommendation vehicle.

### DETAILED DESCRIPTION OF EMBODIMENTS

### Configuration of Battery Electric Vehicle

### Configuration Example of Power System

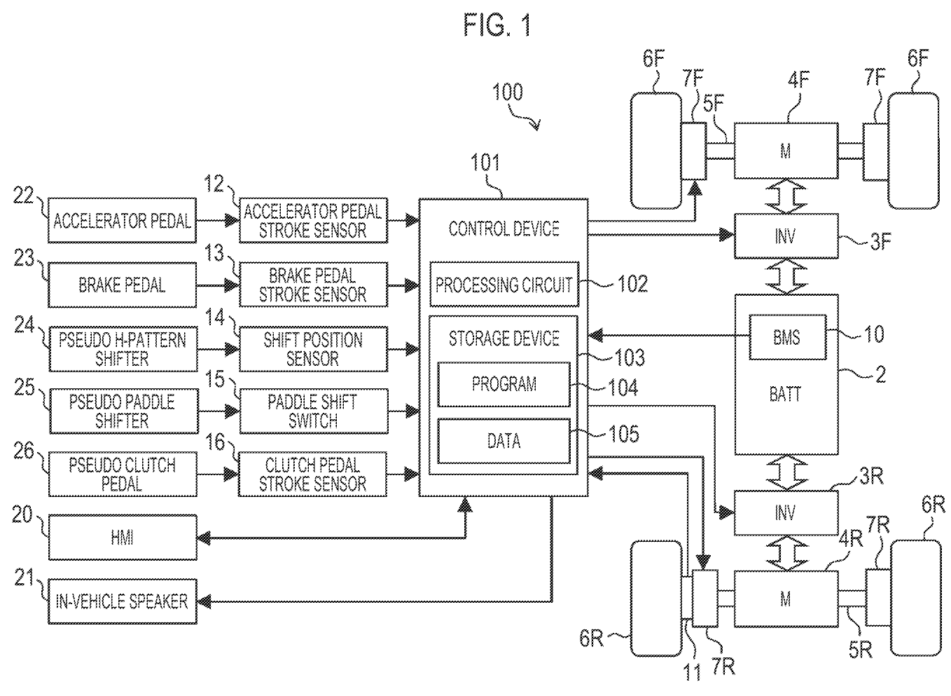

FIG. 1 is a diagram schematically showing a configuration of a battery electric vehicle 100 according to the embodiment of the present disclosure. First, a configuration example of a power system of the battery electric vehicle 100 will be described with reference to FIG. 1.

The battery electric vehicle 100 includes two electric motors (M) 4F, 4R for traveling as a power source on the front and the rear. The electric motors 4F, 4R are, for example, three-phase alternating current motors. The front electric motor 4F is connected to a front drive shaft 5F that drives front wheels 6F. The rear electric motor 4R is connected to a rear drive shaft 5R that drives rear wheels 6R. The front wheels 6F are suspended from right and left independent electronic controlled front suspensions 7F. The rear wheels 6R are suspended from right and left independent electronic controlled rear suspensions 7R.

Each of inverters (INV) 3F, 3R is attached to the front electric motor 4F and the rear electric motor 4R. Each of the front inverter 3F and the rear inverter 3R is connected to a battery (BATT) 2. The battery 2 stores electric energy for driving the electric motors 4F, 4R. That is, the battery electric vehicle 100 is a battery electric vehicle (BEV) that drives by the electric energy stored in the battery 2. The inverters 3F, 3R are, for example, voltage inverters, and control the torque of the electric motors 4F, 4R by PWM control.

### Configuration Example of Control System

Subsequently, a configuration example of a control system of the battery electric vehicle 100 will be described with reference to FIG. 1.

The battery electric vehicle 100 includes a battery management system (BMS) 10. The battery management system 10 is a device that monitors a cell voltage, current, temperature, and the like of the battery 2. The battery management system 10 has a function of estimating a state of charge (SOC) of the battery 2.

The battery electric vehicle 100 includes a vehicle speed sensor 11. At least one of tire-wheel assembly speed sensors (not shown) provided in each of the right and left front wheels 6F and the right and left rear wheels 6R is used as the vehicle speed sensor 11. In addition, the battery electric vehicle 100 includes an accelerator pedal stroke sensor 12. The accelerator pedal stroke sensor 12 is provided in an accelerator pedal 22 and outputs a signal indicating a pressing amount of the accelerator pedal 22, that is, an accelerator operation amount. Further, the battery electric vehicle 100 includes a brake pedal stroke sensor 13. The brake pedal stroke sensor 13 is provided in a brake pedal 23 and outputs a signal indicating a pressing amount of the brake pedal 23, that is, a brake operation amount.

The accelerator pedal 22 and the brake pedal 23 are driving operation members used for driving the battery electric vehicle 100. Separately from the driving operation members, the battery electric vehicle 100 includes a pseudo gearshift operation member that is modeled on an operation member used for a gearshift operation of a manual transmission-equipped engine vehicle (hereinafter, also referred to as an “MT engine vehicle”) as a virtual vehicle. The pseudo gearshift operation member includes a pseudo-H-type shifter 24, a pseudo paddle shifter 25, and a pseudo clutch pedal 26.

The pseudo-H-type shifter 24 is a dummy different from the original H-type shifter. The pseudo-H-type shifter 24 has a structure similar to a shift stick provided in a console and is configured to move between shift positions along an H-shaped gate. Note that the battery electric vehicle 100 does not include a physical transmission, and thus the shift position of the pseudo-H-type shifter 24 is a virtual shift position. A shift position sensor 14 is provided in the pseudo-H-type shifter 24. The shift position sensor 14 outputs a signal indicating the shift position selected by the pseudo-H-type shifter 24.

The pseudo paddle shifter 25 is a dummy different from the original paddle shifter that is a kind of sequential shifter. The pseudo paddle shifter 25 has a structure similar to a shift paddle attached to a steering wheel and can independently move right and left paddles. A paddle shift switch 15 is provided in the pseudo paddle shifter 25. The paddle shift switch 15 outputs an upshift signal when a right paddle is pulled, and outputs a downshift signal when a left paddle is pulled.

The pseudo clutch pedal 26 is a dummy different from a genuine clutch pedal. The pseudo clutch pedal 26 has a structure similar to a clutch pedal included in an MT engine vehicle in the related art. For example, the pseudo clutch pedal 26 includes a reaction force mechanism that generates a reaction force in response to a depression by the driver. A position when a pressing force is not applied is an initial end position of the pseudo clutch pedal 26, and a position when the pseudo clutch pedal 26 is pressed all the way down is a terminal end position of the pseudo clutch pedal 26. The driver can operate the pseudo clutch pedal 26 against the reaction force from the reaction force mechanism from the initial end position to the terminal end position. A clutch pedal stroke sensor 16 is provided in the pseudo clutch pedal 26. The clutch pedal stroke sensor 16 outputs a signal indicating a pressing amount of the pseudo clutch pedal 26. Since the battery electric vehicle 100 does not include a physical clutch, the operation amount of the pseudo clutch pedal 26, that is, the clutch operation amount is a virtual clutch operation amount.

Although the pseudo clutch pedal 26 is a pedal-type operation device operated by foot, a lever-type operation device or a dial-type operation device that is operated by hand may be provided as a pseudo clutch operation device. The pseudo clutch operation device can be operated by the driver from the start end position to the terminal end position against the reaction force and can adopt various structures as long as the driver can feel the operation sense similar to the clutch pedal included in the MT engine vehicle in the related art by the foot or the hand.

In addition, the battery electric vehicle 100 includes a human machine interface (HMI) 20 as a driver interface and an in-vehicle speaker 21. The HMI 20 includes a touch panel display. The HMI 20 displays information on the touch panel display and receives input from the driver through a touch operation on the touch panel display. The in-vehicle speaker 21 provides the driver with the information by voice and can output a pseudo engine sound to be described later. As information particularly related to the embodiment, the input information from the driver includes information (destination information) regarding the destination DES of the battery electric vehicle 100. In addition, the display information of the touch panel display includes information related to a control mode to be described later.

The battery electric vehicle 100 includes a control device 101. The sensors and the control target devices mounted on the battery electric vehicle 100 are connected to the control device 101 by an in-vehicle network. In addition to the battery management system 10, the vehicle speed sensor 11, the accelerator pedal stroke sensor 12, the brake pedal stroke sensor 13, the shift position sensor 14, the paddle shift switch 15, and the clutch pedal stroke sensor 16, various sensors are mounted on the battery electric vehicle 100. The battery management system 10, the vehicle speed sensor 11, and the like are collectively referred to as “internal sensors” of the battery electric vehicle 100, and the information acquired from the internal sensors is collectively referred to as “internal information”.

The control device 101 is typically an electronic control unit (ECU). The control device 101 may be a combination of a plurality of ECUs. The control device 101 includes at least a processing circuit 102 and a storage device 103. The storage device 103 includes a RAM that temporarily records data and a ROM that stores a program 104 or various types of data 105 related to the program, which can be executed by the processing circuit 102. The program 104 is composed of a plurality of instruction codes. The processing circuit 102 reads and executes the program 104 or the data 105 from the storage device 103 and generates the control signal based on the signals acquired from the respective sensors. The number of processing circuits 102 included in the control device 101 may be one or more.

The control device 101 can control the battery electric vehicle 100 in various control modes. The driver can select the control mode by executing the touch operation on the touch panel display of the HMI 20. Specifically, by executing the touch operation on the touch panel display of the HMI 20, one or more programs 104 associated with each of the touch operations are read out from the storage device 103 and executed by the processing circuit 102.

An initial screen of the HMI 20 displays, for example, an option “control mode”. When the option “control mode” is selected, the options “automatic mode” and “manual mode” are displayed on the touch panel display. When the option “automatic mode” is selected, the control mode of the battery electric vehicle 100 is switched to the automatic mode. The automatic mode is a control mode for driving the battery electric vehicle 100 as a normal BEV. In the automatic mode, the driver can basically drive the battery electric vehicle 100 solely by operating the accelerator pedal 22, the brake pedal 23, and a steering wheel (not shown). In the automatic mode, the shift operation of the pseudo H-type shifter 24, the shift operation of the pseudo paddle shifter 25, and the clutch operation of the pseudo clutch pedal 26 are invalidated.

When the option “manual mode” is selected, the control mode of the battery electric vehicle 100 is switched to the manual mode. The manual mode is a control mode for operating the battery electric vehicle 100 like the MT engine vehicle. The manual mode may include a control mode for operating the battery electric vehicle 100 like an automatic transmission-equipped engine vehicle (hereinafter, also referred to as an “AT engine vehicle”) as a virtual vehicle. When the option “manual mode” is selected, for example, the option “category” is displayed on the touch panel display. The option “category” is defined by the purpose and the design objective of an engine vehicle (an MT engine vehicle and an AT engine vehicle, and the following is the same). The option “category” includes “sports car”, “super car”, “sedan”, “showroom car”, “SUV”, “off-road car”, and the like.

In a case where the option “manual mode” is selected, the options “select a category” and “leave it to the system” may be displayed on the touch panel display before the option “category” is displayed on the touch panel display. Then, in a case where the option “select a category” is selected, the option “category” may be displayed on the touch panel display. The option “leave it to the system” is a mode in which the selection of the engine vehicle is entrusted to the battery electric vehicle 100.

When any of the categories in the option “category” is selected, the options “vehicle model name” and “manual/automatic” related to the selected category may be displayed. The driver can set the traveling characteristics and the sound characteristics of the engine vehicle that the driver wants to reproduce in the battery electric vehicle 100 by selecting the category in the option “category” (or the options “vehicle model name” and “manual/automatic”). Then, the travel control and the sound control of the battery electric vehicle 100 are executed in accordance with the set traveling characteristics and the sound characteristics. In the following sections, the travel control and the sound control of the battery electric vehicle 100 by the control device 101 will be described.

### Travel Control of Battery Electric Vehicle

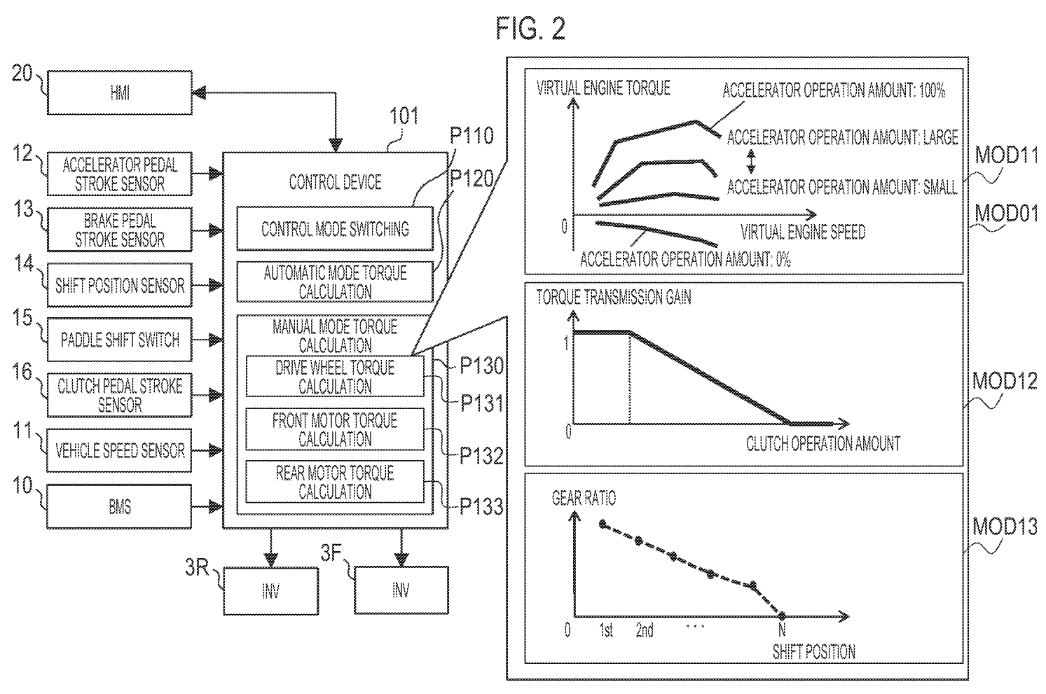

FIG. 2 is a diagram showing a configuration of the control device 101 related to the travel control of the battery electric vehicle 100. Specifically, FIG. 2 shows a configuration particularly relating to torque control in the travel control. One or more programs 104 for travel control stored in the storage device 103 are executed by the processing circuit 102, so that the processing circuit 102 functions as a travel control device.

A control mode signal from the HMI 20 is input to the control device 101 as the travel control device. The control mode signal includes information related to the control mode selected by the driver. The control device 101 executes processing P110 based on the control mode signal. In the processing P110, the control mode is switched in accordance with the control mode signal. In particular, the switching of the control mode that affects the travel control is the switching between the automatic mode and the manual mode.

When the control mode is switched to the automatic mode, the control device 101 executes processing P120 for torque calculation in the automatic mode. In the processing P120, the control device 101 acquires the vehicle speed from a signal of the vehicle speed sensor 11 and acquires the accelerator operation amount from the signal of the accelerator pedal stroke sensor 12. The control device 101 has a motor torque map in which the accelerator operation amount and the vehicle speed are parameters. The control device 101 inputs the vehicle speed and the accelerator operation amount to the motor torque map, and controls the inverters 3F, 3R such that the torque obtained from the motor torque map is generated in the electric motors 4F, 4R.

When the control mode is switched to the manual mode, the control device 101 executes processing P130 for torque calculation in the manual mode. The processing P130 includes processing P131 for calculating torque generated by drive wheels. In addition, the processing P130 includes processing P132 and processing P133. The processing P132 is processing for calculating the torque to be generated in the front electric motor 4F, and the processing P133 is processing for calculating the torque to be generated in the rear electric motor 4R. The processing P132 and the processing P133 are executed in accordance with the drive wheel torque calculated in the processing P130 and torque distribution between the front wheels 6F and the rear wheels 6R.

A vehicle model MOD01 is used to calculate the drive wheel torque in the processing P131. The vehicle model MOD01 includes an engine model MOD11, a clutch model MOD12, and a transmission model MOD13. An engine that is virtually realized by the vehicle model MOD01 is referred to as a virtual engine, a clutch that is virtually realized is referred to as a virtual clutch, and a transmission that is virtually realized is referred to as a virtual transmission. In the engine model MOD11, the virtual engine is modeled. In the clutch model MOD12, the virtual clutch is modeled. In the transmission model MOD13, the virtual transmission is modeled. Each of the engine model MOD11, the clutch model MOD12, and the transmission model MOD13 is constructed corresponding to the option “vehicle category”, for example.

The engine model MOD11 calculates the virtual engine speed and a virtual engine torque. The virtual engine speed is calculated from the vehicle speed, a total reduction ratio, and a slip ratio of a virtual clutch. The virtual engine torque is calculated from the virtual engine speed and the accelerator operation amount. The vehicle speed is acquired from the signal of the vehicle speed sensor 11. The accelerator operation amount is acquired from the signal of the accelerator pedal stroke sensor 12. The total reduction ratio is a numerical value obtained by multiplying a gear ratio of the virtual transmission by a reduction ratio determined by a mechanical structure from the virtual transmission to the drive wheels. In the engine model MOD11, a relationship between the virtual engine speed and the virtual engine torque is defined for each accelerator operation amount.

The clutch model MOD12 calculates a torque transmission gain. The torque transmission gain is a gain for calculating a degree of torque transmission of the virtual clutch corresponding to the clutch operation amount. In the clutch model MOD12, a torque transmission gain is given with respect to the clutch operation amount. The torque transmission gain is converted into a clutch torque capacity of the virtual clutch, that is, a virtual clutch torque capacity. Then, virtual clutch torque to be input to the virtual transmission from the virtual clutch is calculated based on comparison between the virtual clutch torque capacity and the virtual engine torque calculated by the engine model MOD11. Further, in the clutch model MOD12, a value obtained by subtracting the torque transmission gain from 1 is calculated as the slip ratio. The slip ratio is used for calculating the virtual engine speed in the engine model MOD11.

The signal from the paddle shift switch 15 and the signal from the shift position sensor 14 are used to measure the timing of the clutch operation. When the driver's shift operation is detected by the signal from the paddle shift switch 15 or the signal from the shift position sensor 14, the clutch operation model sets the clutch operation amount to the maximum to cut the virtual clutch. The vehicle speed and the virtual engine speed are used for calculating the clutch operation amount. In the clutch operation model, the clutch operation amount is calculated based on a rotation speed difference between a rotation speed of an input shaft of the virtual transmission and the virtual engine speed, such that the rotation speed of the input shaft of the virtual transmission calculated from the vehicle speed and the virtual engine speed are smoothly matched.

The transmission model MOD13 calculates a virtual gear ratio. The virtual gear ratio is a gear ratio determined by a virtual shift position in the virtual transmission. The virtual gear ratio is set for each shift position. The maximum virtual gear ratio is set to first gear, and the virtual gear ratio is reduced in an order of second gear, third gear, fourth gear, and the like.

The transmission model MOD13 calculates the virtual transmission torque by using the virtual gear ratio and the virtual clutch torque. The virtual transmission torque is virtual torque output from the virtual transmission. The control device 101 controls the inverters 3F, 3R such that the output torque of the electric motors 4F, 4R is changed in accordance with the virtual transmission torque. The virtual transmission torque is discontinuously changed in response to the switching of the virtual gear ratio. The discontinuous change in the virtual transmission torque generates a torque shock in the battery electric vehicle 100, and the feeling of a vehicle equipped with a stepped transmission is produced.

The vehicle model MOD01 calculates the drive wheel torque from the virtual transmission torque and the reduction ratio output from the transmission model MOD13.

In the processing P132, the torque distribution rate to the front wheels 6F and the reduction ratio from the output shaft of the front electric motor 4F to the front wheels 6F are multiplied by the drive wheel torque calculated in the processing P131. As a result, the torque (front motor torque) of the front electric motor 4F in the manual mode is calculated. The control device 101 controls the front inverter 3F to cause the front electric motor 4F to generate the front motor torque calculated in the processing P132.

In the processing P133, the torque distribution rate to the rear wheels 6R and the reduction ratio from the output shaft of the rear electric motor 4R to the rear wheels 6R are multiplied by the drive wheel torque calculated in the processing P131. As a result, the torque (rear motor torque) of the rear electric motor 4R in the manual mode is calculated. The control device 101 controls the rear inverter 3R to cause the rear electric motor 4R to generate the rear motor torque calculated in the processing P133.

In the configuration shown in FIG. 2, the battery management system 10 and the brake pedal stroke sensor 13 are not always needed for the travel control. However, in a case where the switching of the control mode affects the SOC of the battery 2, the signal of the battery management system 10 may be used as information for determining the possibility of the switching of the control mode. In addition, in a case where the operation method of the battery electric vehicle 100 is greatly changed, such as the switching between the automatic mode and the manual mode, the condition for the switching may be that the brake pedal 23 is depressed. In that case, the signal of the brake pedal stroke sensor 13 can be used as information for determining that the brake pedal 23 is being depressed.

### Sound Control of Battery Electric Vehicle

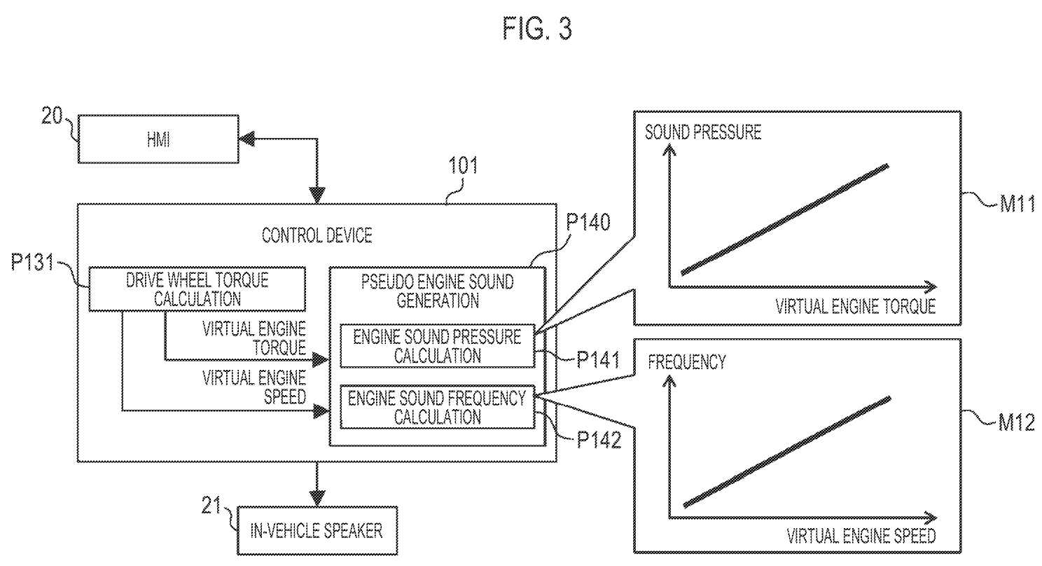

FIG. 3 is a diagram showing a configuration of the control device 101 related to the sound control of the battery electric vehicle 100. One or more programs 104 for sound control stored in the storage device 103 are executed by the processing circuit 102, so that the processing circuit 102 functions as a sound control device. The processing circuit 102 that functions as a torque control device and the processing circuit 102 that functions as a sound control device may be different processing circuits or may be the same processing circuit.

The control device 101 as the sound control device can generate artificially produced sounds from the in-vehicle speaker 21. One of the artificial sounds is a pseudo engine sound imitating an engine sound in an internal combustion engine vehicle in the related art. When a control mode signal indicating that the manual mode is selected from the HMI 20 is input, the control device 101 as a sound control device executes the processing P140. In the processing P140, the pseudo engine sound is generated based on the virtual engine torque and the virtual engine speed calculated in the processing P131.

In the processing P140, the engine sound selected by the HMI 20 is used as a sound source of the pseudo engine sound generated from the in-vehicle speaker 21. Note that, in the processing P140, the sound of the sound source is not used as it is. In the processing P140, for example, the sound pressure of the sound source is changed by an amplifier, and the frequency of the sound source is changed by a frequency modulator.

The processing P140 includes processing P141 of calculating an engine sound pressure and processing P142 of calculating an engine sound frequency. In the processing P141, the sound pressure of the pseudo engine sound is calculated from the virtual engine torque by using the sound pressure map M11. The sound pressure map M11 is created such that the sound pressure is higher as the virtual engine torque is higher. In the processing P142, the frequency of the pseudo engine sound is calculated from the virtual engine speed by using the frequency map M12. The frequency map M12 is created such that the higher the virtual engine speed is, the higher the frequency is. The virtual engine torque and the virtual engine speed are changed by the driver's accelerator operation, the shift operation, and the clutch operation. By changing the sound pressure and the frequency of the pseudo engine sound in accordance with the virtual engine torque and the virtual engine speed that change in such a manner, it is possible to give the driver a sense of reality as the driver is driving a real engine vehicle.

### Setting of Recommendation Vehicle

### Summary

As described above, in a case where the driver who has selected the option “manual mode” further selects any of the categories in the option “category”, the traveling characteristic and the sound characteristic of the engine vehicle that the driver wants to reproduce are set in the battery electric vehicle 100. Alternatively, in a case where the driver who has selected the option “manual mode” selects any of the categories in the option “category” via the option “select a category”, the traveling characteristic and the sound characteristic of the engine vehicle that the driver wants to reproduce are set in the battery electric vehicle 100.

However, a case is estimated, where the traveling experience by the execution of the travel control that reproduces the traveling characteristic of the engine vehicle selected by the driver or the sound control that reproduces the sound characteristic of the engine vehicle selected by the driver does not match what the driver has expected. In this case, there is a possibility that the driver avoids the engine vehicle set at current time in the selection thereafter and selects another engine vehicle. In a case where the traveling experience desired by the driver cannot be obtained even when another engine vehicle is selected, there is even a possibility that the selection of the engine vehicle is avoided.

Therefore, in the embodiment, when the option “manual mode” is selected, the engine vehicle (hereinafter, also referred to as a “recommendation vehicle REC”) recommended by the control device 101 is automatically set when the option “category” is not selected. Alternatively, in a case where the option “manual mode” is selected, the recommendation vehicle REC is automatically set when the option “leave it to the system” is further selected.

### Setting Example

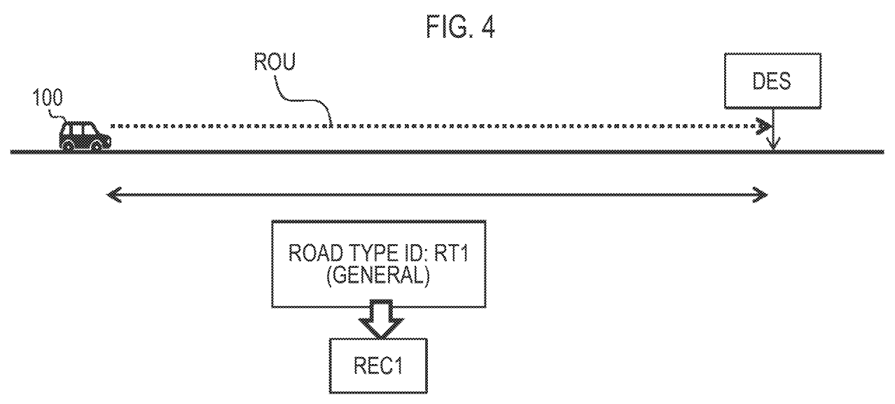

FIG. 4 is a diagram illustrating a setting example of a recommendation vehicle REC. The setting of the recommendation vehicle REC is executed in a case where the destination information of the battery electric vehicle 100 is set. The destination information is acquired from, for example, the navigation function of the HMI 20. The destination information includes a destination DES of the battery electric vehicle 100. Since the navigation function itself is known, a detailed description thereof will be omitted here. However, with the navigation function, the route ROU from the current location of the battery electric vehicle 100 to the destination DES is set with reference to the destination information, the current location information, and the map information. The current location information acquired from a GNSS system mounted on the battery electric vehicle 100 is used. The map information may be used, which is stored in the storage device 103 as data 105, or may be used, which is stored in a device outside the battery electric vehicle 100 (for example, a server).

When the recommendation vehicle REC is set, the characteristics (route characteristics) of the route ROU set based on the destination information are estimated. The route ROU includes information on a road type that constitutes the route ROU. The road type information is, for example, an identification ID of the road type attached to the map information. The route characteristics are estimated by using the information on the road type that constitutes the route ROU. Then, the engine vehicle corresponding to the estimated route characteristics is set as the recommendation vehicle REC.

FIG. 4 shows a case where the identification ID of the road type that constitutes the route ROU is general road (ID: RT1). As a characteristic of the general road, it is considered that the intersections are scattered and a driving operation considering the display of the traffic light or another vehicle traveling on the general road is requested. Therefore, in a case where the road type that constitutes the route ROU is the general road, the engine vehicle that is simple in the driving operation, such as the “sedan” and the “showroom car” corresponding to the characteristic of the general road is set as the recommendation vehicle REC (REC1) that reduces the burden on the driver.

Note that, in a case where the route ROU from the current location to the destination DES is short, the recommendation vehicle REC is set, but the traveling experience that leaves an impression on the driver cannot be provided, and the convenience may be lost. Therefore, the setting of the recommendation vehicle REC is desirably executed in a case where the distance from the current location to the destination DES is equal to or greater than a predetermined distance. The same applies even when the time needed from the current location to the destination DES is short. Therefore, the setting of the recommendation vehicle REC is desirably executed in a case where the time needed is equal to or longer than a predetermined time.

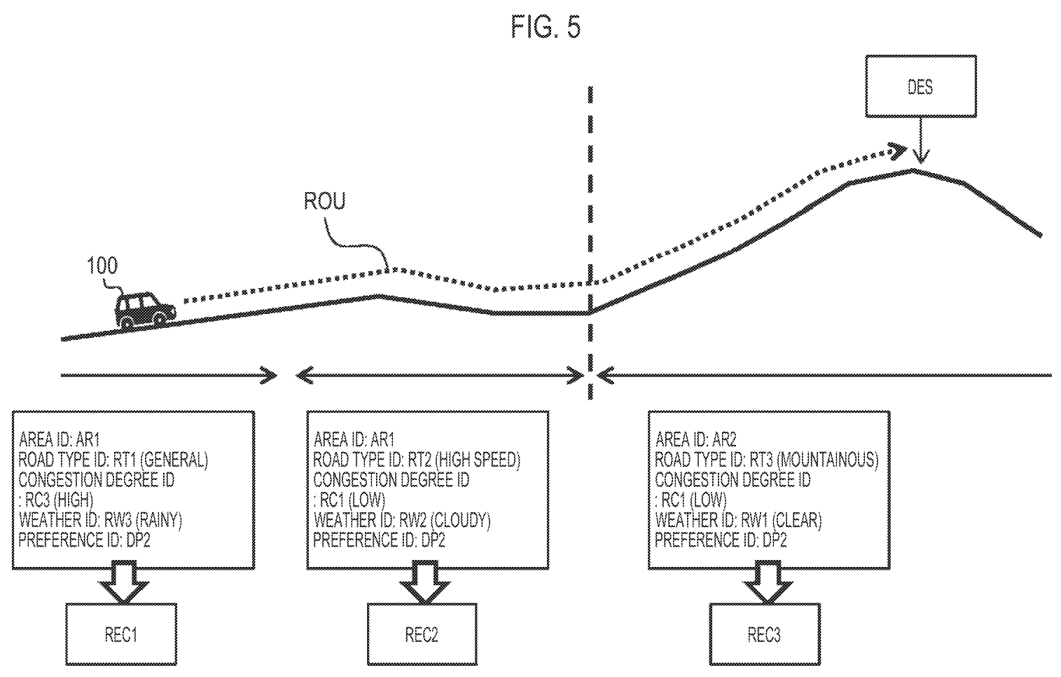

FIG. 5 is a diagram illustrating an application example of the setting of the recommendation vehicle REC. In particular, in a case of long-distance driving, it is estimated that a plurality of road types constitutes the route ROU. In the example shown in FIG. 5, the route ROU is constituted of three types of roads, that is, a general road (ID: RT1), an expressway (ID: RT2), and a mountain road (ID: RT3). Therefore, the characteristics of each of the roads can be estimated, and the engine vehicle corresponding to the characteristics of each of the roads can be set in the recommendation vehicle REC (REC1 to REC3) in each of the parts of the route ROU in which the road type changes.

The characteristic of the general road is as described in the description of FIG. 4. As a characteristic of the expressway, it is considered that a driving operation for testing the performance of the engine vehicle is executed on a road that is straight or has a small curvature. Therefore, in a part of the route ROU in which the road type is the expressway, the engine vehicle that is easy to go at a high speed with a high exhaust volume, such as the “sports car” and the “super car”, is set as the recommendation vehicle REC2. As a characteristic of the mountain road, it is considered that a driving operation that is flexible to the road, such as going up, going down, and going around a curve, is requested. Therefore, in a part of the route ROU in which the road type is the mountain road, the engine vehicle having good handling characteristics or accelerator response, such as the “lightweight sports car”, the “four-wheel drive sports car”, and the “SUV”, is set as the recommendation vehicle REC3.

Further, in FIG. 5, a congestion degree RC (traffic jam degree) of a road of the route ROU or an identification ID of the weather RW is shown. The congestion degree RC is acquired from real-time traffic information, such as information of VICS (registered trademark). The weather RW is acquired from online real-time weather information. The information can be referred to as a situation of the road that constitutes the route ROU (route status). Other information included in the route status includes a time zone. The route status is stored in the storage device 103 as data 105 or is stored in an external device (for example, a server).

When the recommendation vehicle REC is set, the route status may be combined with the route characteristics. In the example shown in FIG. 5, the congestion degree RC of the part of the road where the identification ID of the road type is the general road (ID: RT1) is high (ID: RC3), and the weather RW is rain (ID: RW3). When the road is congested or when the road surface condition is poor, the engine vehicle, such as the “sedan” and the “showroom car” corresponding to the characteristic of the general road, and the engine vehicle of the automatic transmission type having a small acceleration change with respect to the accelerator operation (that is, the AT engine vehicle) can be set as the recommendation vehicle REC1. On the other hand, the congestion degree RC of the part of the road where the identification ID of the road type is the expressway (ID: RT2) is low (ID: RC1), and the weather RW is cloudy (ID: RW3). Therefore, in the part, the engine vehicle, such as the “sports car” and the “super car”, and the engine vehicle of the manual transmission type having a large acceleration change with respect to the accelerator operation (that is, the MT engine vehicle) can be set as the recommendation vehicle REC2.

Further, in FIG. 5, an identification ID of the driver preference DP is shown. The driver preference DP is estimated by classifying the driver into a type close to the driver's traveling concept based on a selection history of the option “category” (or the options “vehicle model name” and “manual/automatic”) by the driver of the battery electric vehicle 100, for example. As another example, the driver preference DP may be set by the driver inputting the traveling concept that the driver prefers to the HMI 20. Examples of the traveling concept include fun to drive, easy to drive, and comfort to drive. The traveling concepts are stored in the storage device 103 as data 105 in association with any of the engine vehicles, such as a “sports car” that matches the concept of fun to drive, an AT engine vehicle that matches the concept of easy to drive, and a “showroom car” that matches the concept of comfort to drive.

When the recommendation vehicle REC is set, the driver preference DP may be combined with the route characteristics. In the example shown in FIG. 5, the identification ID of the driver preference is the one of the concepts of easy to drive (ID: DP2). In this case, the AT engine vehicle of the “sedan” is set in the part of the route ROU in which the road type is the general road, the AT engine vehicle of the “sports car” is set in the part of the route ROU in which the road type is the expressway, and the AT engine vehicle of the lightweight “sports car” is set in the part of the route ROU in which the road type is the mountain road, in each of the recommendation vehicles REC (REC1 to REC3).

### Processing Flow

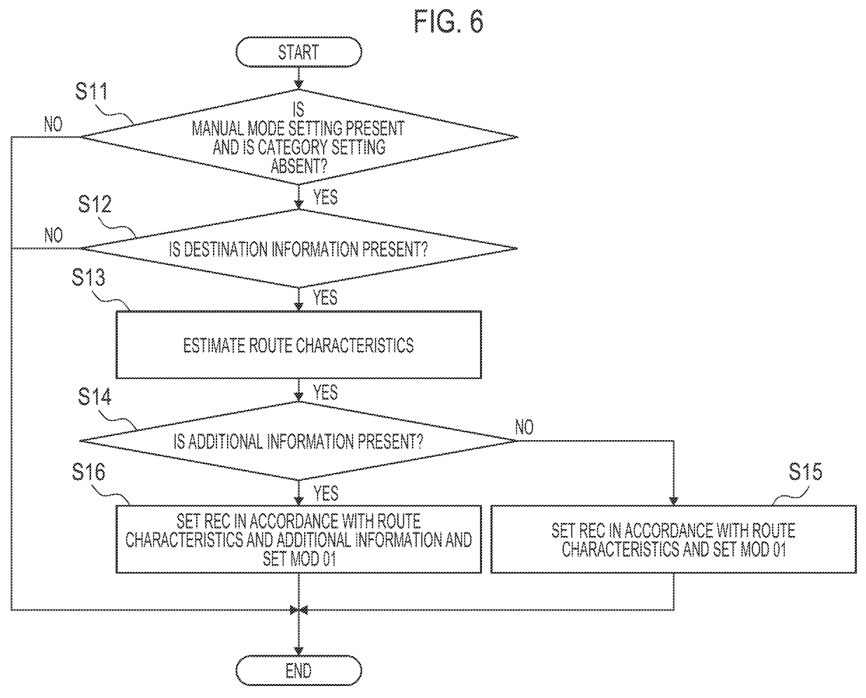

The computer processing for setting the recommendation vehicle REC can be represented by a flowchart shown in FIG. 6. The routine of the flowchart shown in FIG. 6 is executed by the control device 101 shown in FIG. 1 at a predetermined cycle, for example.

In the routine shown in FIG. 6, first, the processing of S11 is executed. In the processing of S11, determination is made whether the control mode is set to the manual mode and the option “category” is not set. For example, when a predetermined time elapses after the option “manual mode” is selected and any of the categories in the option “category” is not selected, determination is made that the control mode is set to the manual mode and the option “category” is not set. In a case where the option “leave it to the system” is set, the processing of S11 may be executed based on whether the option “leave it to the system” is selected.

When the determination result of S11 is negative, the processing ends. When the determination result of S11 is affirmative, the processing of S12 is executed. In the processing of S12, determination is made whether the destination information is set. The destination information is acquired from, for example, the navigation function of the HMI 20.

When the determination result of S12 is negative, the processing ends. When the determination result of S12 is affirmative, the processing of S13 is executed. In the processing of S13, the route characteristics are estimated. Specifically, first, the current location information of the battery electric vehicle 100 is acquired. Then, the route ROU from the current location to the destination DES is set based on the destination information and the current location information of the battery electric vehicle 100 and the map information. Then, the route characteristics are estimated based on the identification ID of the road type that constitutes the route ROU.

Subsequently to the processing of S13, the processing of S14 is executed. In the processing of S14, determination is made whether the additional information is present or not. Examples of the additional information include the route status, such as the congestion degree RC, the weather RW, and the time zone, and the driver preference DP. When determination is made that the additional information is not present, the processing of S15 is executed. On the other hand, in a case where determination is made that the additional information is present, the processing of S16 is executed.

In the processing of S15, the recommendation vehicle REC in accordance with the route characteristics estimated in S13 is set. On the other hand, in the processing of S16, the recommendation vehicle REC is set in accordance with the route characteristics estimated in S13 and the additional information. Then, the vehicle model MOD01 corresponding to the set recommendation vehicle REC is set. As a result, the travel control and the sound control of the battery electric vehicle 100 are executed to reproduce the traveling characteristic and the sound characteristic of the recommendation vehicle REC.

### Other Embodiments

As another configuration of the battery electric vehicle 100, the battery electric vehicle 100 may include solely the pseudo-H-type shifter 24 and the pseudo clutch pedal 26 without including the pseudo paddle shifter 25. In addition, as another configuration of the battery electric vehicle 100, the battery electric vehicle 100 may include solely the pseudo paddle shifter 25 without including the pseudo-H-type shifter 24 and the pseudo clutch pedal 26. Further, as another configuration of the battery electric vehicle 100, the battery electric vehicle 100 may include solely the pseudo-H-type shifter 24 without including the pseudo paddle shifter 25 and the pseudo clutch pedal 26.

What is claimed is:

1. A battery electric vehicle that includes an electric motor as a power source for traveling and that is configured to execute travel control simulating traveling of a plurality of virtual vehicles, the battery electric vehicle comprising:
one or more storage devices configured to store a plurality of virtual vehicle models for executing the travel control, and internal information of the battery electric vehicle; and
one or more processing circuits configured to execute driving control of the battery electric vehicle that includes the travel control,
wherein the one or more processing circuits are configured to, in the driving control,
estimate, in a case where destination information of the battery electric vehicle is set, route characteristics from a current location of the battery electric vehicle to a destination based on the destination information,
select a recommendation vehicle in accordance with the route characteristics from among the virtual vehicles, and
execute, based on the internal information and a virtual vehicle model corresponding to the recommendation vehicle, travel control simulating traveling of the recommendation vehicle.

2. The battery electric vehicle according to claim 1, wherein:
the one or more storage devices are configured to further store a route status from the current location to the destination; and
the one or more processing circuits are configured to select, in the driving control, the recommendation vehicle in accordance with the route characteristics and the route status.

3. The battery electric vehicle according to claim 1, wherein:
in the one or more storage devices, the virtual vehicles are classified based on traveling concepts set in advance; and
the one or more processing circuits are configured to select, in the driving control, in a case where preference information related to a traveling concept of a driver of the battery electric vehicle is set, the recommendation vehicle in accordance with the route characteristics and the traveling concept.

4. The battery electric vehicle according to claim 1, wherein the one or more processing circuits are configured to select, in the driving control, the recommendation vehicle in a case where a vehicle category of a virtual vehicle is not selected by a driver of the battery electric vehicle.

5. The battery electric vehicle according to claim 1, wherein the one or more processing circuits are configured to select, in the driving control, the recommendation vehicle in a case where a distance from the current location to the destination is equal to or greater than a predetermined distance.
